(19) United States
(12) Patent Application Publication
(10) Pub. No.: US 2014/0019324 A1
(43) Pub. Date: Jan. 16, 2014

(54) Delivery System for Futures Contracts

(71) Applicants: John Nyhoff, Darien, IL (US); Steve Youngren, Elgin, IL (US); Sandra Ro, London (GB); Richard Co, Chicago, IL (US); John Labuszewski, Westmont, IL (US)

(72) Inventors: John Nyhoff, Darien, IL (US); Steve Youngren, Elgin, IL (US); Sandra Ro, London (GB); Richard Co, Chicago, IL (US); John Labuszewski, Westmont, IL (US)

(73) Assignee: CHICAGO MERCANTILE EXCHANGE INC., Chicago, IL (US)

(21) Appl. No.: 13/546,083

(22) Filed: Jul. 11, 2012

(51) Int. Cl. G06Q 40/04

(52) U.S. Cl. 705/37

(57) ABSTRACT

Systems and methods are provided for processing and settling futures contracts that have multiple settlement provisions. A single futures contract may include both a physical delivery settlement provision and a cash settlement provision. Cash settlement provisions may involve inconvertible currencies.

### FIELD OF THE INVENTION

The present invention relates to trading systems and methods. More particularly, embodiments of the invention relate to settlement mechanisms for the settlement of futures contracts.

### DESCRIPTION OF THE RELATED ART

Futures contracts generally obligate buyers and sellers to purchase and sell an asset at a predetermined time and at a predetermined price. Assets may include physical commodities and financial instruments. Currency futures contracts are exemplary financial instruments. A currency futures contract obligates parties to different currencies at a predetermined price on a predetermined date.

Futures contracts can specify settlement by physical delivery or by cash. Settling a futures contract with physical delivery involves delivering the asset. For example, a quantity of corn may be delivered by transfer of a receipt evidencing ownership of corn stored in a specified grain elevator or reciprocal payments of a specified quantity of one or more currency for an equivalent quantity of another currency may be made to settle the futures contract. Alternatively, some futures contracts specify that they will be cash settled. Cash settlement may include a cash payment that is the difference between a spot price and the price specified by the futures contract.

Cash settlement is convenient for parties not wishing to take or transfer actual possession of underlying assets. For example, a party may wish to hedge risks associated with the price of oil by purchasing an oil futures contract and the party may have no desire or ability to take possession of oil at the end of the contract. Physical delivery may be preferred by some traders and for some futures contracts. For example, some traders prefer physical delivery of currencies associated with currency futures contracts.

Physical delivery is not always a practical option for settlement of futures contracts because of government regulations and other sources that restrict the free flow of assets. There is a need in the art for systems and methods that increase settlement options available to traders.

### SUMMARY OF THE INVENTION

Embodiments of the present invention overcomes the problems and limitations of the prior art by providing systems and methods for processing orders for and settling futures contracts that have multiple settlement provisions. A single futures contract may include both a physical delivery settlement provision and a cash settlement provision.

Various embodiments of the invention may include or process futures contracts based on multiple currencies. Portions of the futures contract based on inconvertible currencies may be cash settled while other portions may be settled with physical delivery.

In other embodiments, the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention;

FIG. 2 illustrates an exemplary futures contract, in accordance with an embodiment of the invention;

FIG. 3 illustrates an exemplary list of countries and corresponding currencies; and

FIG. 4 illustrates a process that may be used to match and settle orders for futures contracts that have multiple settlement provisions, in accordance with an embodiment of the invention.

### DETAILED DESCRIPTION OF THE INVENTION

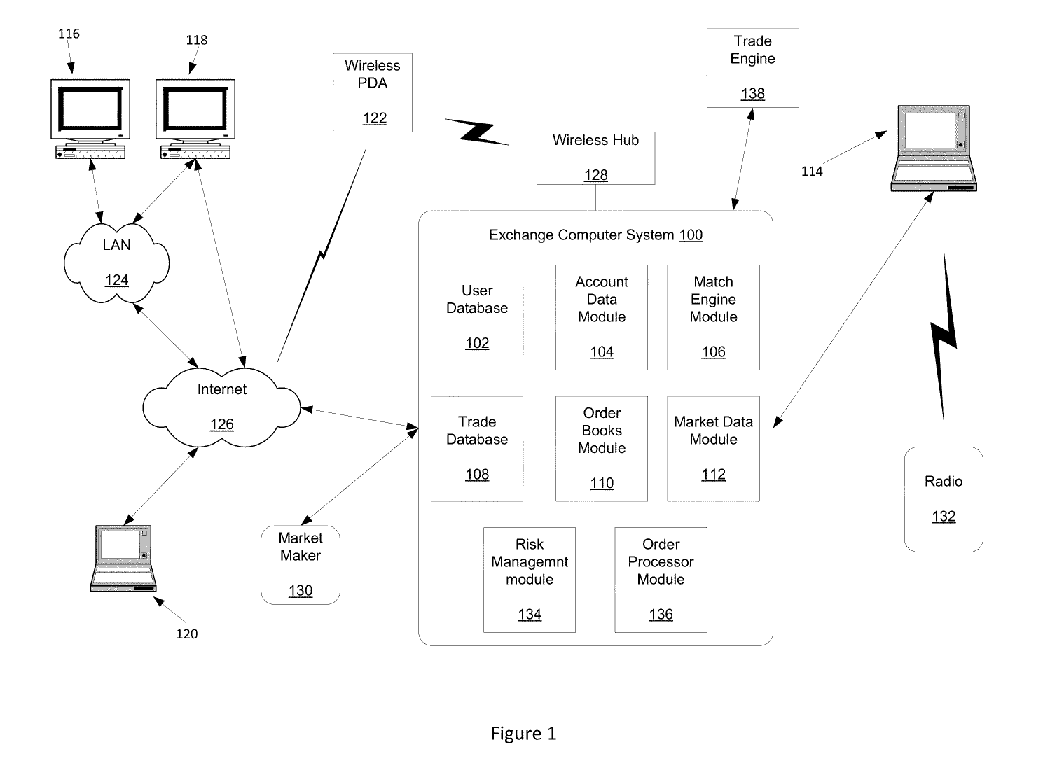

Aspects of the present invention may be implemented with computer devices and computer networks. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to process orders for further processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

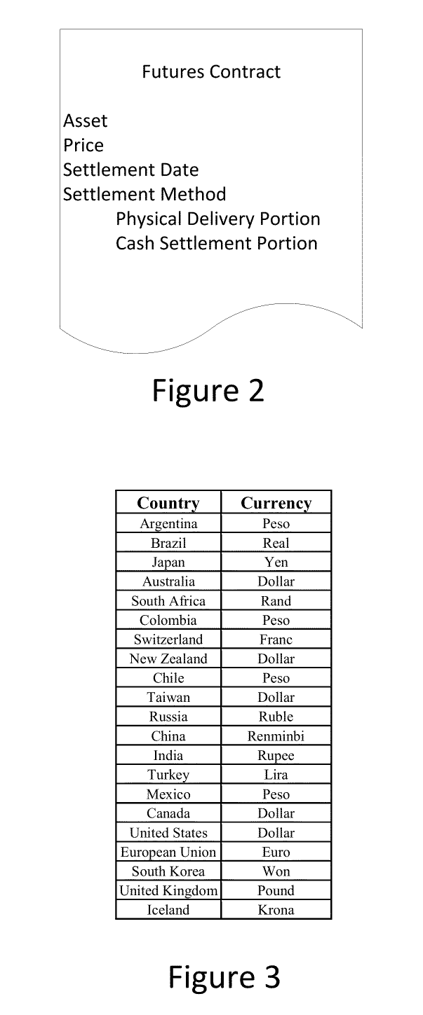

FIG. 2 illustrates an exemplary futures contract 200, in accordance with an embodiment of the invention. Futures contract 200 may include conventional terms such as the identification of an asset, a price and a settlement date. Futures contract 200 also includes a hybrid settlement provision that includes a physical delivery portion and a cash settlement portion. Physical delivery may be preferred and cash settlement may be used when physical delivery is impractical or not possible.

Exemplary futures contracts may include currency futures contracts. Some futures contracts may include a basket of currencies. FIG. 3 illustrates an exemplary list of countries and corresponding currencies. In some embodiments of the invention inconvertible currencies are cash settled and the remaining currencies are settled by physical delivery. A currency may be considered inconvertible when the currency cannot be exchanged for another currency because of foreign exchange regulations or other barriers that make it impossible or impractical to exchange the currency.

One exemplary futures contract may include an index futures contract based on the U.S. dollar (USD), Euro (EUR), Japanese yen (JPY), British pound (GBP), a carry index, a commodity country index and a BRIC index. A carry index is designed to reflect the total return of an “Intelligent Carry Strategy,” which through an objective and systematic methodology, seeks to capture the returns that are potentially available from a strategy of investing in high-yielding currencies with the exposure financed by borrowings in low-yielding currencies sometimes referred to as the “carry trade.” An exemplary carry index is the CME Carry Index and represents a basket of equally weighted positions (as of Dec. 31, 2010) which is effectively long a basket including the Australian dollar (AUD), Brazilian real (BRL), Mexican peso (MXN), New Zealand dollar (NZD), South African rand (ZAR) and Turkish lira (TRY) vs. short positions in the USD and EUR. A commodity country index may include currencies for countries whose national income is tied heavily to commodity production. An exemplary commodity country index is the CME Commodity Country Index and is constructed to be effectively long AUD, BRL, CAD, Norwegian krone (NOK), NZD and ZAR vs. a short position in USD. A BRIC index may include currencies for countries that have experienced rapid growth over the past decade or two, generally outperforming the so-called developed market economies by a wide margin. Countries currently include Brazil, Russia, India and China. An exemplary BRIC index is the CME BRIC Index and is constructed of equal weightings of long Brazilian real (BRL), Russian ruble (RUB), Indian rupee (INR) and Chinese yuan (CNY) vs. a short position in the USD.

The futures contract may be nominally valued at $50×Index value. Thus, if Index value=995.67, this implies a nominal value of $49,783.62 (=$50×995.67). Minimum price increment or “tick” size may equal to 0.10 Index points or $5.00 (=$50×0.10). These futures contracts may be settled using a hybrid physical delivery and cash settlement process. Physical delivery may be used for currency pairs involving readily obtainable or convertible currencies, e.g., EUR vs. USD, JPY vs. USD, GBP vs. USD, etc. Cash settlement may be used for inconvertible currencies, such as CNY, INR, BRL, etc. During settlement, the convertible currencies may be delivered, i.e., the foreign currency is delivered vs. a payment denominated in USD, upon final settlement. These payments may be based on the respective spot values of the currency pairs proportionate to their weighting in the index. As an example, if the index futures contract is calculated at 995.67 on a particular day, the futures contract is nominally valued at $49,783.62 (=$50×995.67). The USD vs. EUR component of the Index represented 14.82% of the Index by weight and the currency pair is quoted at 0.7715. Thus, the seller is required to pay the buyer the sum of $7,375.97 upon delivery (=14.82%×$49,793.62). The buyer is required to pay the seller the sum of 5,690.90 Euros (=0.7715×$7,375.97). The USDJPY, USDGBP, USDCHF, USDCAD and USDAUD components of the Index are similarly settled through the delivery process.

The USDCNY component of the index futures contract may be settled in cash based upon the change in the spot value of the index component on the business day prior to final settlement to the final settlement date. For example, if the USDCNY rate fell from 6.3163 to 6.3004 from the day prior to final settlement to the final settlement date. The “calibrated” value of this index component similarly fell from 136.703 to 136.359, noting that all Index components are calibrated such that the Index is valued nominally at 1,000.00 as of Dec. 31, 2010. If we take $50 times these calibrated valued, the USDCNY Index component fell from $6,835.16 to $6,917.94 from the day prior to final settlement to the final settlement date. Thus, the buyer is marked-to-market at a debit of $17.23 (46,917.94−$6,835.16) while the seller is marked-to-market with a credit of $17.23.

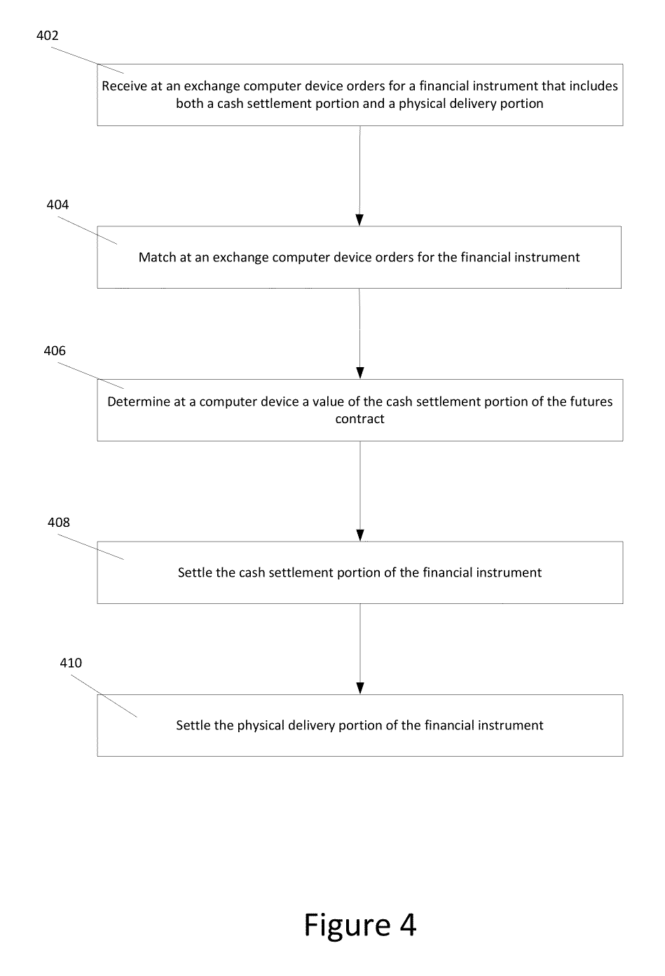

FIG. 4 illustrates a process that may be used to match and settle orders for futures contracts that have multiple settlement provisions, in accordance with an embodiment of the invention. First, in step 402 orders for a financial instrument that includes both a cash settlement portion and a physical delivery portion is received at an exchange computer device. The financial instrument may be a futures contract based on one or more currencies. In step 404, orders for the financial instrument are matched. Step 404 may be performed at an exchange computer module, such as at match engine module 106 (shown in FIG. 1). After orders are matched, an exchange or other matching entity may distribute market data or perform other conventional processes.

In step 406 a value of the cash settlement portion of the futures contract is determined. Step 406 may be performed at a computer device and may include determining cash settlement values of one or more components that include inconvertible currencies. Next, the cash settlement portion of the financial instrument may be settled in step 408. In some embodiments, settlement of the physical delivery portion of the financial instrument may be performed in step 410.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention.

What is claimed is:

1. A method of settling a obligations associated with a financial instrument that includes both a cash settlement portion and a physical delivery portion, the method comprising:
(a) determining at a computer device a value of the cash settlement portion of the futures contract; and
(b) settling the cash settlement portion of the financial instrument.

2. The method of claim 1, wherein the financial instrument comprises a futures contract.

3. The method of claim 2, wherein the futures contract comprises a currency futures contract.

4. The method of claim 3, wherein the currency futures contract comprises a basket of currencies.

5. The method of claim 4, wherein the basket of currencies comprises at least one inconvertible currency that is cash settled.

6. The method of claim 1, further including:
settling the physical delivery portion of the financial instrument.

7. The method of claim 1, wherein (b) comprises:
settling at a computer device the cash settlement portion of the financial instrument.

8. A method of processing orders for financial instruments, the method comprising:
(a) receiving at an exchange computer device orders for a financial instrument that includes both a cash settlement portion and a physical delivery portion; and
(b) matching at an exchange computer device orders for the financial instrument.

9. The method of claim 8, wherein the financial instrument comprises futures contract.

10. The method of claim 9, wherein the futures contract comprises a currency futures contract.

11. The method of claim 10, wherein the currency futures contract comprises a basket of currencies.

12. The method of claim 11, wherein the basket of currencies comprises at least one inconvertible currency that is cash settled.

13. The method of claim 8, further including:
(c) determining at a computer device a value of the cash settlement portion of the futures contract; and
(d) settling the cash settlement portion of the financial instrument.

14. The method of claim 13, further including:
(e) settling the physical delivery portion of the financial instrument.

15. A tangible computer-readable medium containing computer-executable instructions that when executed cause a computer device to perform the steps comprising:
(a) determining at a computer device a value of the cash settlement portion of the futures contract; and
(b) settling the cash settlement portion of the financial instrument.

16. The tangible computer readable medium of claim 15, wherein the financial instrument comprises futures contract.

17. The tangible computer readable medium of claim 16, wherein the futures contract comprises a currency futures contract.

18. The tangible computer readable medium of claim 17, wherein the currency futures contract comprises a basket of currencies.

19. The tangible computer readable medium of claim 18, wherein the basket of currencies comprises at least one inconvertible currency that is cash settled.

20. The tangible computer readable medium of claim 15, wherein the inconvertible currency comprises the Renminbi.
